(19) United States
(12) Patent Application Publication
(10) Pub. No.: US 2012/0070012 A1
(43) Pub. Date: Mar. 22, 2012

(54) NOISE REDUCTION SYSTEM FOR AN ELECTRICALLY POERED AUTOMOTIVE VEHICLE

(75) Inventors: Takashi Yoshizawa, Novi, MI (US); Harsha Badarinarayan, Canton, MI (US); Donald J. McCune, Farmington Hills, MI (US); Akira Inoue, Farmington Hills, MI (US)

(73) Assignee: Hitachi, Ltd, Tokyo (JP)

(21) Appl. No.: 12/885,939

(22) Filed: Sep. 20, 2010

(51) Int. Cl. G10K 11/16

(52) U.S. Cl. 381/71.4

(57) ABSTRACT

A noise reduction system for an automotive vehicle powered at least in part by an electric motor located separately from the passenger compartment. The system includes at least one sensor which produces an output signal having a frequency, amplitude and phase representative of noise generated by the electric motor. At least one speaker is positioned closely adjacent the electric motor. A speaker output controller receives the output from the sensor as an input signal and generates an output signal to the speaker so that the speaker produces an audible signal having substantially the same frequency and amplitude but inverted in phase relative to the output from the sensor.

### BACKGROUND OF THE INVENTION

I. Field of the Invention

The present invention relates generally to noise reduction systems and, more particularly, to a noise reduction system for an automotive vehicle powered at least in part by an electric motor.

Ii. Description of Related Art

In a conventional automotive vehicle of the type powered by a fuel engine, the sound from the combustion of the fuel in the engine forms the dominant noise source for the vehicle whenever the engine is running. Such combustion engines contain various frequency components and usually mask other noises from the engine compartment originating from auxiliary systems.

Conversely, in an automotive vehicle at least partially powered by an electric motor, such as an electric vehicle or a hybrid electric vehicle, the vehicle can operate when the combustion engine is not running or there is no engine at all. Consequently, the noise from the electric motor, which is unique to both electric vehicles and hybrid electric vehicles, is not masked by the sound of the combustion engine.

The noise from an electric motor in an electric vehicle or hybrid electric vehicle is usually a mix of pure tone sound together with its harmonics. Additionally, the frequency of the sound is typically much higher than the engine noise of a conventional internal combustion engine powered vehicle.

Humans, however, are more sensitive to higher frequency noise, i.e. noise in the range of 500 hertz-10 kilohertz, than to the lower frequency noise from a conventional internal combustion engine. Attempts to dampen or absorb such high frequency noise from an electric vehicle or hybrid electric vehicle by the inclusion of sound-absorbing material not only consumes engine volume and space, but is also expensive both in material and labor costs thus increasing the overall cost of the vehicle.

There have, however, been previously known active noise control systems for automotive vehicles which utilize the speakers within the vehicle passenger compartment to cancel engine noise. In the well-known fashion, these active noise control systems ideally generate sound of the same frequency and amplitude, but inverted phase, of the engine noise resulting in cancellation of the overall noise within the passenger compartment of the vehicle.

Unfortunately, these active noise control systems for automotive vehicles, while proving effective at lower noise frequencies common to internal combustion engines, are ineffective at higher audible frequencies of the type common to the motors of the type used in electric vehicles and hybrid electric vehicles. Instead, due to the relatively shorter wavelength of the high frequency audible signal, noise cancellation within the passenger compartment by using the passenger compartment speakers is achieved only in small spots and, worse, in other spots the noise is amplified rather than canceled.

### SUMMARY OF THE PRESENT INVENTION

The present invention provides a noise reduction system for an automotive vehicle powered at least in part by an electric motor. Such vehicles are known as electric vehicles or hybrid electric vehicles, i.e. vehicles with both an internal combustion engine as well as an electric motor which power the vehicle.

In brief, in the present invention at least one sensor is provided which produces an output signal having a frequency, amplitude and phase representative of the noise generated by the electric motor. Although a wide variety of different sensors may be utilized, one or more piezoelectric elements may be mounted between the stator of the motor and the motor casing, or on the surface of the motor casing, or between the motor casing and the transmission case, or on the transmission case, which generate an output signal in response to vibration of the electric motor. This vibration causes the electric motor to generate noise at the same frequency as the vibration.

At least one speaker is positioned closely adjacent the electric motor and thus closely adjacent the source of the noise from the electric motor. A speaker output controller receives the output signal from the sensor and generates an output signal to the speaker or speakers having substantially the same frequency and amplitude, but inverted in phase, as the estimated motor noise. Such a speaker output effectively cancels the noise from the electric motor. Furthermore, since the speaker is positioned at or at least closely adjacent the source of the noise, the noise cancellation is effective throughout the passenger compartment. Moreover, the piezoelectric elements may absorb the vibration energy of the electric motor and convert it to electrical power. This energy harvesting feature not only reduces the motor vibration and noise, but also supplies power to the speakers and speaker controller, eliminating the necessity of additional power supply to them.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating a vehicle with the noise cancellation system of the present invention;

FIGS. 2A-2D are diagrammatic views illustrating a portion of the system of the present invention;

FIG. 3 is a diagrammatic view illustrating the system of the present invention;

FIG. 4A is a schematic view illustrating a preferred embodiment of the present invention;

FIG. 4B is a view similar to FIG. 4A, but illustrating a modification thereof;

FIG. 5 is a diagrammatic chart illustrating the system of the present invention; and

FIG. 6 is a diagrammatic view of the pedestrian warning system.

### DETAILED DESCRIPTION OF PREFERRED EMBODIMENTS OF THE PRESENT INVENTION

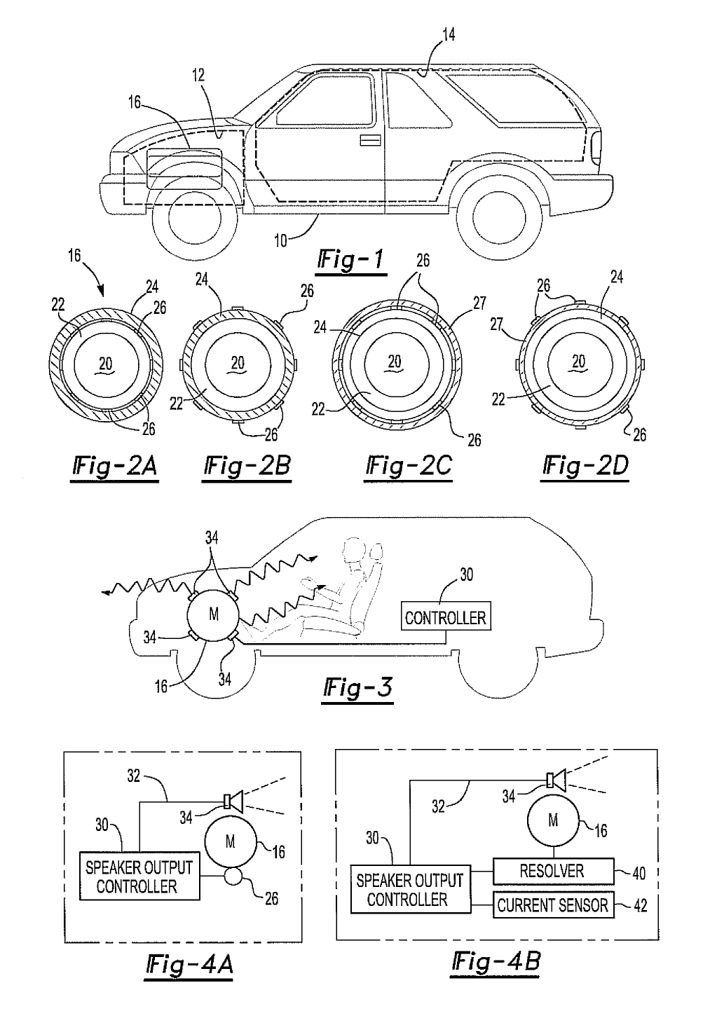

With reference first to FIG. 1, an automotive vehicle 10 is shown having an engine compartment 12 as well as a passenger compartment 14 separate from the engine compartment 12. In the conventional fashion, the passengers (not shown) are positioned within the passenger compartment 14 and thus spaced from the engine compartment 12.

The vehicle 10 is powered at least in part by an electric motor 16 which may be contained within the engine compartment 12. Thus, the vehicle 10 may be either an all-electric vehicle in which the electric motor 16 provides all of the power to propel the vehicle 10, or a hybrid electric vehicle which contains an internal combustion engine in addition to the electric motor 16 to power the vehicle 10. In either case, in at least some circumstances, the electric motor 16 provides the sole propulsion for the vehicle 10. It is during those periods of operation of the automotive vehicle 10 where noise cancellation for the relatively high frequency noises generated by the electric motor 16 is desirable.

With reference now to FIG. 2A, the motor 16 is illustrated in cross section and includes a rotor 20, stator 22, as well as a motor casing 24 extending around the stator 22. Most of the noise generated by the motor 16 results in vibration of the motor 16, e.g. vibration between the stator 22 and the motor casing 24. This vibration will, of course, vary in frequency depending upon the rotational speed of the motor 16 and will also vary in amplitude depending upon the torque load requirements demanded from the motor 16 by the operator of the vehicle. A higher torque load, e.g. during acceleration, results in greater amplitude of the noise signal and vice versa.

One or more vibration sensors 26, such as piezoelectric elements, are positioned at spaced apart locations around the source of the noise, motor 16, at such position that vibration energy is efficiently absorbed, e.g. between the motor casing 24 and the stator 22. The compressive and tensile deformation of the piezoelectric elements would have an effect of absorbing the vibration energy, thus reducing the noise from the motor. However, the vibration sensors may alternatively be positioned at other locations around the motor 16 without deviation from the spirit or scope of the instant invention, such as on the surface of the motor casing 24. If the motor 16 is stored in a transmission case, the piezoelectric elements may be positioned between the motor casing 24 and the transmission case, or on the surface of the transmission case.

With reference now to FIG. 2B, the sensors 26 may alternatively, or additionally, be positioned on the outside of the motor casing 24. Alternatively, as shown in FIG. 2C, a transmission case 27 is disposed around the motor casing so that the sensors 26 are positioned at the source of the noise, e.g. between the motor casing 24 and the transmission case 27. A still further modification is shown in FIG. 2D in which the sensors are mounted on the outside of the transmission case 27.

With reference now to FIG. 4A, an output signal from the vibration sensor or sensors 26, which is directly related to the frequency, amplitude, and phase of the noise generated by the electric motor 16, is coupled as an input signal to a speaker output controller 30. The speaker output controller 30 then generates an output signal on its output 32 to a speaker 34 which is substantially the same in frequency and amplitude as the estimated noise from the motor 16, but in which the phase is inverted.

Unlike the previously known systems, however, the speaker 34 is mounted closely adjacent the source of the noise, e.g. the motor 16, the transmission, etc. As such, the cancellation of the noise by the phase inverted audible signal from the speaker 34 effectively cancels out the electric motor noise throughout the passenger compartment 14. This can be explained by the formulas followed. If d1−d2=(n+φ/2/pi−1/2)λ (λ: wavelength of sound, φ: phase difference of noise source and speaker sound, d1: distance between the noise source and target point, d2: distance between the target point and the speaker), the noise will be cancelled. However, in the target vicinity point if d1′−d2′=(n+φ/2pi)λ (λ: wavelength of sound, φ: phase difference of noise source and speaker sound, d1': distance between the noise source and target vicinity point, d2′: distance between the target vicinity point and the speaker), the noise would rather be amplified. When the frequency is relatively low, the wavelength is long, thus the equation d1′−d2′=(n+φ/2pi)λ would not easily be met. However, as the frequency goes up, the wavelength gets shorter, and the equation could be easily met at target vicinity area if the noise source and the speaker are not located close to each other. If driver moves his head a little bit, the noise changes a lot and the noise level is even worth, thus having the speaker close to the noise source is effective for cancelling the noise at high frequencies common to motors used in electric vehicles or hybrid electric vehicles.

It will, of course, be appreciated that one or more speakers 34 may be utilized adjacent to the motor 16 to cancel the noise from the electric motor 16. An example of actual implementation on an electric vehicle or hybrid electric vehicle is illustrated in FIG. 3. Speakers 34 are attached on the motor 16 so that the noise from the motor 16 can be cancelled out by the sound from the speakers 34 throughout the whole space. If a piezoelectric element is used as the vibration detector 26, the piezoelectric element also absorbs vibration energy and produces an output voltage signal during vibration. This voltage output signal may be employed or harvested through the controller 30 to provide the power to the speaker 34. In this case, no additional power is required to generate the noise from the speaker 34 for the noise cancellation system.

It will be understood, of course, that other types of sensors 26 may be used in lieu of a piezoelectric element. For example, a simple microphone could form the sensor 26. In that case, the microphone would provide an output signal to the speaker output controller 30 which varies in both frequency and amplitude in a manner well known to microphones.

With reference now to FIG. 4B, a modification of the invention is shown in which a resolver 40 coupled to the motor 16 provides a signal on its output to the speaker output controller 30 which gives the information of the rotational speed and the rotation timing of the motor 16, and thus of the frequency and the phase of vibration of the motor 16. Similarly, a current sensor 42 is electrically connected to the motor and provides an output signal to the speaker output controller 30 which varies as a function of the torque of the motor 16. An increased current provides an increased torque which also provides an increase in the amplitude of the noise generated by the electric motor 16.

In this case, the speaker output controller is programmed to use the data inputs from both the resolver 40 (which may be either analog or digital in nature) as well as the current sensor 42 to determine the appropriate output signal on its output 32 to the speaker 34 to cancel the motor noise. The speaker 34 creates a noise at a frequency and amplitude substantially the same as the motor noise, but inverted in phase. Such inversion cancels the motor noise throughout substantially the entire passenger compartment.

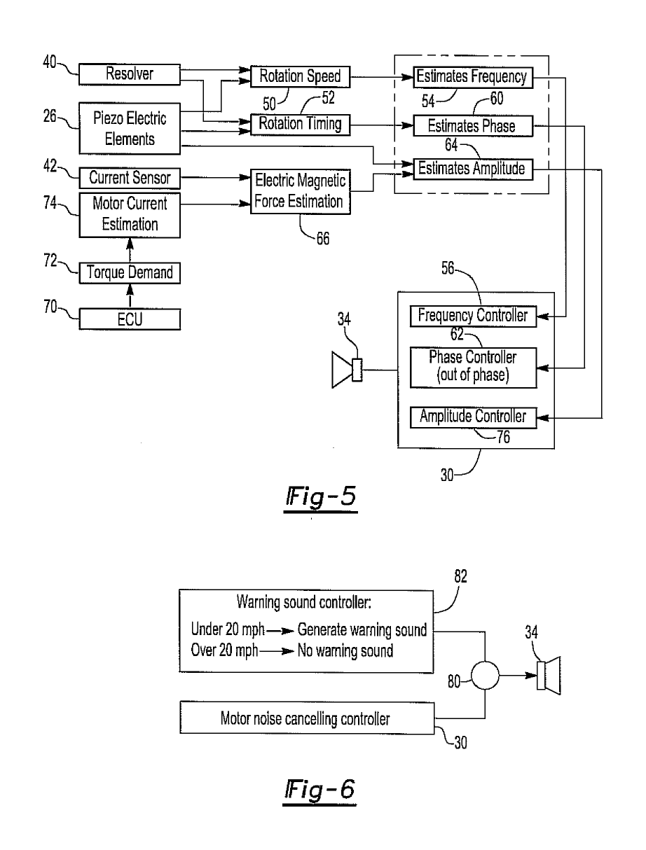

With reference now to FIG. 5, the operation of the speaker output controller is there illustrated diagrammatically. The resolver 40, if present, provides an output signal related to both rotational speed 50 as well as rotational timing 52 of the electric motor 16. Similarly, if piezoelectric elements are used as the sensor 26, the output signal from the piezoelectric elements is also directly related to both rotational speed 50 as well as rotational timing 52.

Once the rotational speed 50 is determined from either the resolver 40 or sensors 26, or both, a frequency of the noise is determined or at least estimated at block 54. That estimate is then coupled as an input signal to a frequency controller 56 in the speaker output controller 30.

Similarly, once the rotational timing 52 is determined, either from the resolver, sensor 26, or both, the phase estimate of the noise from the motor 16 may be determined at block 60. The signal from block 60 is then coupled as an input signal to a phase controller 62 in the speaker output controller 30 which ensures that the phase generated by the controller 30 is inverted in phase from the motor noise.

Still referring to FIG. 5, the sensor 26 also provides an output signal to block 64 which estimates the amplitude of the noise from the motor 16. For example, a greater amplitude of signal from the piezoelectric element when used as a sensor 26 is indicative of a greater amplitude of noise from the motor 16, and vice versa.

However, if the resolver 40 is utilized without the sensor 26, additional circuitry must be used to estimate the amplitude of the motor noise at block 64. Consequently, the current sensor 42, if present, provides an output signal to an electric magnetic force estimation block 66. The block 66 in turn provides a signal to the block 64 which estimates the amplitude of the noise signal from the motor 16. A higher current is indicative of a higher motor torque and, in turn, indicative of a higher amplitude of noise from the motor 16.

In lieu of the current sensor, the electric magnetic force estimation block 66 may receive a signal from the engine control unit 70 which provides an output signal 72 indicative of the torque demand on the motor 16. From that motor torque demand, a motor current estimation may be made at block 74 and coupled as an input signal to the electric magnetic force estimation block 66.

Regardless of how the amplitude is estimated at block 64, block 64 is coupled to an amplitude controller 76 in the speaker output controller 30. Consequently, the speaker output controller determines the frequency, phase, and amplitude of the output signal from the controller 30 to the speaker 34 to cancel, or at least greatly reduce, the noise from the motor 16.

From the foregoing, it can be seen that the present invention provides an effective system for canceling noise generated by the electric motor in either an electric vehicle or hybrid electric vehicle. Since the speakers are placed closely adjacent the motor, and thus closely adjacent the noise source, noise cancellation within the passenger compartment 14 even at high frequencies is achieved.

As an additional feature of the present invention, the noise generated by the speaker 34 may also be used as a pedestrian warning noise since both electric vehicles and hybrid electric vehicles are very quiet as contrasted to internal combustion engines of the type used in automotive vehicles. For example, as shown in FIG. 6, the motor noise cancelling controller 30 connects its output to a signal combiner 80 having its output coupled as an input signal to the speaker 34. The combiner 80, however, also receives an input signal from a warning sound controller 82 so that the output signal to the speakers is the superimposition of the signals from both controllers 30 and 82. The warning sound controller 82, however, only produces an output signal at low speeds, e.g. less than 20 miles per hour, so that the pedestrian warning signal is only generated at said low speeds.

Having described our invention, many modifications thereto will become apparent to those skilled in the art to which it pertains without deviation from the spirit of the invention as defined by the scope of the appended claims.

We claim:

1. A noise reduction system for an automotive vehicle powered at least in part by an electric motor and which produces noise from a noise source during operation comprising:
at least one sensor which produces an output signal having a frequency, amplitude and phase representative of noise generated by the noise source,
at least one speaker positioned closely adjacent the noise source,
a speaker output controller which receives said output signal from said sensor as an input signal and generates an output signal to said at least one speaker, said output signal having substantially the same amplitude and frequency but inverted in phase as the noise from the noise source.

2. The noise reduction system as defined in claim 1 wherein said at least one speaker comprises a plurality of speakers attached evenly and point-symmetrically on the surface of the noise source, having at least one speaker oriented to the passenger compartment.

3. The noise reduction system as defined in claim 1 wherein said at least one sensor comprises a piezoelectric element attached to the noise source.

4. The noise reduction system as defined in claim 3 wherein said at least one piezoelectric element comprises a plurality of spaced apart piezoelectric elements.

5. The noise reduction system as defined in claim 4 wherein said piezoelectric elements are attached on the surface of the noise source.

6. The noise reduction system as defined in claim 4 wherein said noise source comprises an electric motor and wherein said piezoelectric elements are sandwiched between the stator of the electric motor and the motor casing.

7. The noise reduction system as defined in claim 1 wherein the noise source is a transmission case surrounding an electric motor and wherein said at least one sensor comprises a piezoelectric element sandwiched between the electric motor and the transmission case.

8. The noise reduction system as defined in claim 7 wherein said piezoelectric elements are attached on the surface of the transmission case.

9. The noise reduction system as defined in claim 1 wherein the noise source comprises an electric motor and wherein said at least one sensor comprises a resolver which produces an output signal representative of the rotational speed and rotation timing of the electric motor.

10. The noise reduction system as defined in claim 1 wherein said at least one sensor comprises a microphone.

11. The noise reduction system as defined in claim 1 wherein the noise source comprises an electric motor and wherein said at least one sensor comprises a current sensor which produces an output signal representative of the electric current of the electric motor.

12. The noise reduction system as defined in claim 1 wherein the noise source comprises an electric motor and wherein said at least one sensor comprises an electronic control unit having an output signal representative of the torque demand of the electric motor.

13. The noise reduction system as defined in claim 3 wherein said at least one piezoelectric element provides power to drive said at least one speaker.

14. The noise reduction system as defined in claim 1 wherein said at least one speaker generates a pedestrian warning audible signal.

15. The noise reduction system as defined in claim 14 where said pedestrian warning audible signal is generated only at automotive vehicle speeds less than a predetermined threshold.
